(19) United States
(12) Patent Application Publication
(10) Pub. No.: US 2015/0263564 A1
(43) Pub. Date: Sep. 17, 2015

(54) ENERGY STORAGE SYSTEM AND METHOD FOR DRIVING THE SAME

(71) Applicant: Samsung SDl Co., Ltd., Yongin-si (KR)

(72) Inventor: Byeong-Seon Min, Yongin-si (KR)

(21) Appl. No.: 14/608,734

(22) Filed: Jan. 29, 2015

(30) Foreign Application Priority Data
Mar. 12, 2014 (KR) 10-2014-0029085

(51) Int. Cl. H02J 7/00; H02J 4/00

(52) U.S. Cl. CPC H02J 7/0091; H02J 4/00

(57) ABSTRACT

An energy storage system and a method for driving the same are disclosed. In one aspect, the energy storage system comprises a battery system and a power management system. The battery system includes at least one battery cell and a battery management system configured to measure and output the temperature of the battery cell. The power management system is configured to receive power from a power generation system, transfer the received power to the battery cell, and control the amount of power to be charged in and discharged from the battery cell based at least in part on the temperature.

### INCORPORATION BY REFERENCE TO ANY PRIORITY APPLICATIONS

This application claims priority to and the benefit of Korean Patent Application No. 10-2014-0029085, filed on Mar. 12, 2014, in the Korean Intellectual Property Office, the entire contents of which are incorporated herein by reference in their entirety.

### BACKGROUND

1. Field

The described technology generally relates to an energy storage system and a method for driving the same.

2. Description of the Related Technology

As concern grows for environmental disruption and natural resource depletion, demand for a high capacity energy storage increases. In addition to the system, the importance of renewable energy has increased. Here, the renewable energy does not generally cause pollution during power generation. An energy storage system is a system which generates and transmits renewable energy to a load (e.g., a home), a battery system for storing power, and existing grids.

Recently, a method for operating an energy storage system in a zero house mode has gained interest. The zero house mode is an operation mode in which power generated from renewable energy is consumed in a house and it is unnecessary to receive separate power input from a grid.

### SUMMARY OF CERTAIN INVENTIVE ASPECTS

One inventive aspect is an energy storage system and a method for driving the same, which can reduce the temperature of a battery cell to a predetermined threshold value or less when the battery cell is charged.

Another aspect is an energy storage system, including: a battery system configured to include at least one battery cell; and a power management system configured to charge the battery cell, using power of a power generation system, and supply the power of the power generation system and the power of the battery cell to a load, wherein the battery system further includes a battery management system for measuring a temperature of the battery cell and outputting information on the temperature of the battery cell, and wherein the power management system controls the amount of power charged in the battery cell, based on the information on the temperature of the battery cell when the battery cell is charged.

The power management system can include a power converting unit configured to control the amount of power output from the power generation system; and an integrated controller configured to control the power converting unit, based on the information on the temperature of the battery cell.

When the temperature of the battery cell is greater than a first threshold value, the integrated controller can control the power converting unit to reduce the amount of power charged in the battery cell by reducing the amount of power output from the power generation system.

When the temperature of the battery cell is no more than the first threshold value, the integrated controller can control the power converting unit to increase the amount of power charged in the battery cell by increasing the amount of power output from the power generation system.

When the temperature of the battery cell is no more than the first threshold value and greater than a second threshold value, the integrated controller can control the power converting unit to maintain the amount of power charged in the battery cell by maintaining the amount of power output from the power generation system.

When the temperature of the battery cell is no more than a second threshold value, the integrated controller can control the power converting unit to increase the amount of power charged in the battery cell by increasing the amount of power output from the power generation system.

The power management system can further include an inverter connected between the power converting unit and a grid or the load, the inverter converting a DC voltage from the power converting unit into an AC voltage and supplying the converted AC voltage to the grid or the load; and a converter connected between the power converting unit and the battery system, the converter converting the voltage from the power converting unit into a DC voltage for charging the battery cell and then outputting the converted DC voltage when the battery cell charged, and converting the voltage from the battery cell into a DC voltage to be supplied to the inverter when the battery cell is discharged.

Another aspect is a method for driving an energy storage system which includes a battery rack having at least on battery cell, and a power management system for controlling the charging and discharging of the battery cell, the method including: measuring a temperature of the battery cell and outputting information on the temperature of the battery cell; and controlling the amount of power charged in the battery cell, based on the information on the temperature of the battery cell when the battery cell is charged.

The controlling of the amount of power charged in the battery cell, based on the information on the temperature of the battery cell, when the battery cell is charged, can include reducing the amount of power charged in the battery cell by reducing the amount of power output from a power generation system when the temperature of the battery cell is greater than a first threshold value.

The controlling of the amount of power charged in the battery cell, based on the information on the temperature of the battery cell, when the battery cell is charged, can include increasing the amount of power charged in the battery cell by increasing the amount of power output from the power generation system when the temperature of the battery cell is no less than the first threshold value.

The controlling of the amount of power charged in the battery cell, based on the information on the temperature of the battery cell, when the battery cell is charged, can include maintaining the amount of power charged in the battery cell by maintaining the amount of power output from the power generation system when the temperature of the battery cell is no more than the first threshold value and greater than a second threshold value.

The controlling of the amount of power charged in the battery cell, based on the information on the temperature of the battery cell, when the battery cell is charged, can include increasing the amount of power charged in the battery cell by increasing the amount of power output from the power generation system when the temperature of the battery cell is no more than the second threshold value.

According to the described technology, when the temperature of the battery cell is greater than a predetermined threshold value, the energy storage system controls the output voltage of the power generation system to be controlled, thereby lowering the output power of the power generation system. As a result, when the temperature of the battery cell is greater than the predetermined threshold value, the amount of power charged in the battery cell can be reduced, thereby lowering the temperature of the battery cell.

Further, when the temperature of the battery cell is no more than the predetermined threshold value, the energy storage system controls the output voltage of the power generation system to be controlled, thereby increasing the output power of the power generation system. As a result, when the temperature of the battery cell is no more than the predetermined threshold, the amount of power charged in the battery cell can be increased, thereby increasing the charging speed of the battery cell.

Another aspect is an energy storage system comprising a battery system, a power generation system, and a power management system. The battery system includes at least one battery cell having a first power and a battery management system configured to measure and output the temperature of the battery cell. The power generation system is configured to generate and output a second power. The power management system is configured to receive the second power, charge the battery cell with the second power, supply the first and second powers to a load, and control the amount of the second power to be charged based at least in part on the temperature.

In the above energy storage system, the power management system includes a power converter configured to control the amount of the second power to be charged and an integrated controller configured to control the power converter based at least in part on the temperature. In the above energy storage system, the power converter is further configured to reduce the amount of the second power to be charged when the temperature of the battery cell is greater than a first threshold value. In the above energy storage system, the power converter is configured to increase the amount of the second power to be charged when the temperature of the battery cell is less than or equal to the first threshold value.

In the above energy storage system, the power converter is further configured to maintain the amount of the second power to be charged when the temperature of the battery cell is less than or equal to the first threshold value and greater than a second threshold value. In the above energy storage system, the power converter is configured to increase the amount of the second power to be charged when the temperature of the battery cell is less than or equal to the second threshold value.

In the above energy storage system, the power management system further includes an inverter and a DC-DC converter. In the above energy storage system, the inverter is electrically connected between the power converter and a grid or the load. In the above energy storage system, the inverter is configured to convert a direct current (DC) voltage received from the power converter into an AC voltage and supply the converted AC voltage to the grid or the load. In the above energy storage system, the DC-DC converter is electrically connected between the power converter and the battery system. In the above energy storage system, the DC-DC converter is configured to convert the voltage output of the power converter into a first DC voltage when the battery cell is being charged, transfer the first DC voltage which is the same as the second power, convert the second power received from the battery cell into a second DC voltage when the battery cell is being discharged, and transfer the second DC voltage to the inverter.

Another aspect is a method for driving an energy storage system, the method comprising measuring the temperature of a battery cell and controlling the amount of power to be charged in the battery cell based at least in part on the measured temperature when the battery cell is being charged.

The above method further comprises outputting power at a power generation system, wherein the controlling includes reducing the amount of the power output from the power generation system so as to reduce the power charged in the battery cell when the temperature of the battery cell is greater than a first threshold value. In the above method, the controlling further includes increasing the amount of the power output from the power generation system so as to increase the power charged in the battery cell when the temperature of the battery cell is equal to or more than the first threshold value.

In the above method, the controlling further includes maintaining the amount of the power output from the power generation system so as to maintain the power charged in the battery cell when the temperature of the battery cell is less than or equal to the first threshold value and greater than a second threshold value. In the above method, the controlling further includes increasing the amount of the power output from the power generation system so as to increase the amount of the power charged in the battery cell when the temperature of the battery cell is less than or equal to the second threshold value.

Another aspect is an energy storage system comprising a battery system and a power management system. The battery system includes at least one battery cell and a battery management system configured to measure and output the temperature of the battery cell. The power management system is configured to receive power from a power generation system, transfer the received power to the battery cell, and control the amount of power to be charged in and discharged from the battery cell based at least in part on the temperature.

In the above energy storage system, the power management system includes a power converter and an integrated controller. In the above energy storage system, the power converter is configured to control the amount of the received power to be transferred. In the above energy storage system, the integrated controller is configured to control the power converter based at least in part on the temperature of the battery cell. In the above energy storage system, the power converter is further configured to reduce the amount of the received power to be transferred when the temperature of the battery cell is greater than a first threshold value.

In the above energy storage system, the power converter is further configured to maintain the amount of received power to be transferred when the temperature of the battery cell is less than or equal to the first threshold value and greater than a second threshold value. In the above energy storage system, the power converter is further configured to increase the amount of received power to be transferred when the temperature of the battery cell is less than or equal to the second threshold value.

In the above energy storage system, the power management system further includes an inverter and a bidirectional DC-DC converter. In the above energy storage system, the inverter is electrically connected between the power converter and a grid or a load. In the above energy storage system, the inverter is configured to convert a direct current (DC) voltage received from the power converter into an AC voltage and supply the converted AC voltage to the grid or the load. In the above energy storage system, the bidirectional DC-DC converter is electrically connected between the power converter and the battery system. In the above energy storage system, the bidirectional DC-DC converter is configured to convert the voltage output from the power converter into a first DC voltage when the battery cell is being charged, convert the voltage output from the battery cell into a second DC voltage when the battery cell is being discharged, and transfer the second DC voltage to the inverter.

### BRIEF DESCRIPTION OF THE DRAWINGS

FIG. 1 is a block diagram schematically illustrating an energy storage system and peripheral components thereof according to an embodiment.

FIG. 2 is a block diagram illustrating in detail the energy storage system of FIG. 1.

FIG. 3 is a flowchart illustrating in detail a method for controlling the amount of power charged in a battery cell.

FIG. 4 is a graph illustrating a relationship between output voltage and output power of a power generation system.

FIG. 5 is another flowchart illustrating in detail the method for controlling the amount of power charged in the battery cell.

### DETAILED DESCRIPTION OF CERTAIN INVENTIVE EMBODIMENTS

When the energy storage system is operating in the zero house mode, a plurality of battery cells included in a battery system are repeatedly charged/discharged, and therefore, the temperature of the battery cells increase. This temperature increase can cause damage to the energy storage system. In order to prevent this problem, a method has been proposed for reducing the temperature of the battery cell by using a fan. However, when the fan is used, power consumption by the house increases, and therefore, it is disadvantage in the zero house mode. In addition, the lifespan of the fan is not long, and hence replacement and service costs increase.

In the following detailed description, only certain exemplary embodiments of the present invention have been shown and described, simply by way of illustration. As those skilled in the art would realize, the described embodiments can be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In this disclosure, the term “substantially” includes the meanings of completely, almost completely or to any significant degree under some applications and in accordance with those skilled in the art.

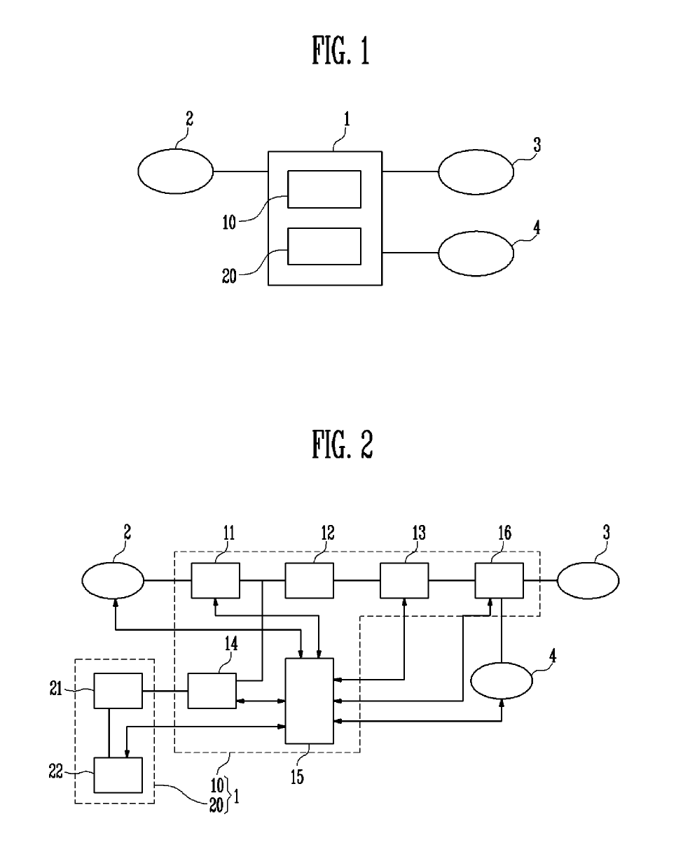

FIG. 1 is a block diagram schematically illustrating an energy storage system and peripheral components thereof according to an embodiment of the described technology.

Referring to FIG. 1, the energy storage system 1 according to this embodiment supplies power to a load 4 in connection with a power generation system 2 and a grid 3.

The energy storage system 1 includes a power conversion system or power management system 10 and a battery system 20. The power conversion system 10 can control the power supply of the battery system 20, the power generation system 2 and the grid 3. The power conversion system 10 supplies power received from the power generation system 2, the grid 3 and the battery system 20 into a suitable form for the grid 3, the load 4, and the battery system 20.

The power conversion system 10 can store power generated from the power generation system 2 in the battery system 20. The power conversion system 10 can supply the power generated from the power generation system 2 to the grid 3, and store the power supplied from the grid 3 in the battery system 20.

When the grid 3 is operating normally, the power conversion system 10 supplies the power supplied from the grid 3 to the load 4 and/or the battery system 20. When the grid 3 is operating abnormally (e.g., when a power failure occurs in the grid 3), the power conversion system 10 can supply power to the load 4 by performing an uninterruptible power supply (UPS) operation. Even when the grid 3 is operating normally, the power conversion system 10 can supply, to the load 4, power generated by the power generation system 2 or power stored in the battery system 20.

The power generation system 2 is a system which generates power using an energy source. The power generation system 2 supplies the generated power to the energy storage system 1. The power can be generated using renewable energy. For example, the power generation system 2 can be a solar power generation system, a wind power generation system, and a tidal power generation system, but the described technology is not limited thereto. A solar cell of a solar power generation system uses sunlight and can be easily installed in each house, factory or the like. The power generation system 2 can include a high-capacity energy system which includes a plurality of power generation modules connected in parallel and generates power for each power generation module.

The grid 3 can include a power plant, a substation, power lines, and the like. When the grid 3 is operating normally, the grid 3 supplies power to the energy storage system 1 and receives power from the energy storage system 1. When the grid 3 is operating abnormally, the grid 3 does not supply power to the energy storage system 1, and the energy storage system 1 also does not supply power to the grid 3.

The load 4 consumes power generated by the power generation system 2, power stored in the battery system 20, or power supplied from the grid 3. A house, a factory or the like can be included in the load 4.

The energy storage system 1 according to this embodiment can be operated in a zero house mode. The zero house mode is a mode in which the load 4 consumes only power generated from the power generation system 2. When the energy storage system 1 is operating in the zero house mode, it is unnecessary to receive separate power input from the grid 3.

FIG. 2 is a block diagram illustrating in detail the energy storage system of FIG. 1.

Referring to FIG. 2, the energy storage system 1 includes a power conversion system 10 and a battery system 20.

The power conversion system 10 converts power received from the power generation system 2, the grid 3 and the battery system 20 into a suitable form for the grid 3, the load 4, and the battery system 20. The power conversion system 10 supplies the converted power to the grid 3, the load 4, and the battery system 20. The power conversion of the power conversion system 10 can be DC/AC conversion and conversion between first and second voltages. Specifically, the power conversion system 10, as shown in FIG. 2, can include a power converting unit or power converter 11, a DC link unit 12, an inverter 13, a converter or DC-DC converter or bidirectional DC-DC converter 14, an integrated controller 15 and a switch circuit 16.

The power converting unit 11 is a power converting device electrically connected between the power generation system 2 and the DC link unit 12. The output voltage of the power converting unit 11 is a DC voltage. The power converting unit 11 can be configured with a power conversion circuit including a converter or a rectifier circuit according to the type of the power generation system 2. For example, when a DC voltage is output from the power generation system 2, the power converting unit 11 can include a converter for converting the DC voltage into a DC voltage suitable for the DC link unit 12. Alternatively, when an AC voltage is output from the power generation system 2, the power converting unit 11 can be a rectifier circuit for converting the AC voltage of the power generation system 2 into a DC voltage suitable for the DC link unit 12.

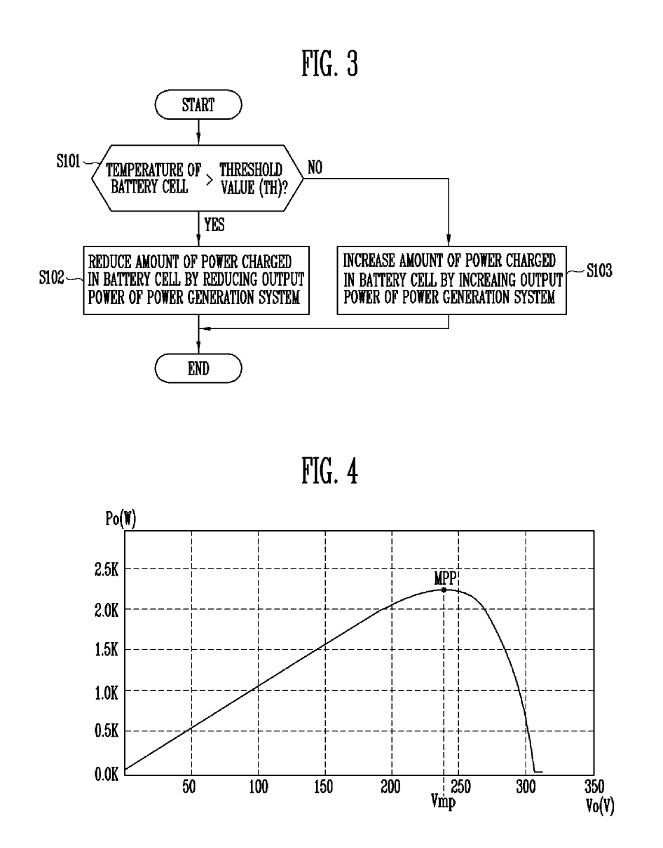

When the power generation system 2 is a solar power generation system, the power converting unit 11 can perform a maximum power point tracking (MPPT) of the power generation system 2 so as to obtain maximum power output from the power generation system 2 according to solar radiation, temperature or the like. In addition to the MPPT, the power converting unit 11 can control the amount of power generated from the power generation system 2 under the control of the integrated controller 15. This will be described in detail in conjunction with FIGS. 3 and 5.

The DC link unit 12 is electrically connected between the power converting unit 11 and the inverter 13 so as to substantially constantly maintain a DC link voltage. The DC link unit 12 can be used to prevent the DC link voltage from becoming unstable due to an instantaneous voltage drop in the power generation system 2 or the grid 3, a sudden change or a high level in the power demand of the load 4, etc. The DC link unit 12 can include a large-capacity capacitor so as to substantially constantly maintain the DC link voltage.

The inverter 13 is a power converting device electrically connected between the DC link unit 12 and the grid 3 or the load 4. The inverter 13 can convert the DC link voltage from the DC link unit 12 into an AC voltage for the grid 3 or the load 4. The inverter 13 can include a rectifier circuit to rectify the AC voltage from the grid 3 and to convert the rectified AC voltage into a DC voltage. That is, the inverter 13 can be a bidirectional inverter.

The inverter 13 can include a predetermined filter to remove harmonics from the AC voltage output to the grid 3 or the load 4. Also, the inverter 13 can include a phase-locked loop (PLL) circuit for matching the phase of the AC voltage output from the inverter 13 to the phase of the AC voltage of the grid 3 so as to prevent reactive power loss. In addition, the inverter 13 can perform other functions such as restriction of voltage variation range, power factor correction, removal of DC components, and protection against transient phenomena. Also, when the inverter 13 is not used, the operation of the inverter 13 can be stopped so as to reduce power consumption.

The converter 14 is a power converting device connected between the DC link unit 12 and the battery system 20. The converter 14 can convert the DC voltage output from the battery system 20 into a DC voltage for the inverter 13. In addition, the converter 14 can convert the DC voltage output from the power converting unit 11 or the inverter 13 into a DC voltage for the battery system 20. That is, the converter 14 is a DC-DC converter, and can be a bidirectional converter. Meanwhile, when the converter 14 is not used, the operation of the converter 14 can be stopped so as to reduce power consumption.

The integrated controller 15 can monitor states of the power generation system 2, the grid 3, the load 4 and the battery system 20, and can control operations of the power converting unit 11, the inverter 13, the converter 14 and the battery system 20 according to the monitoring results. For example, the integrated controller 15 can monitor whether a power failure occurs in the grid 3, whether the power generation system 2 generates power, an amount of power generated by the power generation system 2, a state of charge (SOC) of a battery cell of the battery system 20, an amount of power consumed by the load 4, power consumption time, and the like.

In some embodiments, the integrated controller 15 can monitor information on a temperature of the battery cell when the battery cell is charged, and control an amount of power charged in the battery cell, based on the information on the temperature of the battery cell. In some embodiments, the integrated controller 15 controls the power converting unit 11, based on the information on the temperature of the battery cell, so that it is possible to control the amount of power generated by the power generation system 2. Accordingly, it is possible to control the amount of power charged in the battery cell. This will be described in detail later in conjunction with FIGS. 3 and 5.

The switch circuit 16 is connected among the inverter 13, the grid 3 and the load 4. The switch circuit 16 can control the flow of current between the inverter 13 and the grid 3 and the flow of current between the inverter 13 and the load 4 by performing an on/off operation under the control of the integrated controller 15. In the zero house mode, the switch circuit 16 can cut off the flow of current between the inverter 13 and the grid 3. In some embodiments, in the zero house mode, the energy storage system 1 does not receive power from the exterior, and can supply power to the load 4, using only the power generated from the power generation system 2. In some embodiments, when the power consumed by the load 4 is greater than the sum of the power generated from the power generation system 2 and the power stored in the battery system 20, the integrated controller 15 can stop the operation in the zero house mode, and control the switch circuit 16 to allow the flow of current between the inverter 13 and the grid 3.

The battery system 20 stores power supplied from the power generation system 2 and/or the grid 3, and supplies the power stored in the grid 3 or the load 4. Referring to FIG. 2, the battery system 20 includes at least one battery cell 21 and a battery management system 22.

The battery cell 21 can be included in a plurality of battery cells connected in series. The battery cell 21 can be implemented with various secondary batteries. For example, the battery cell 21 can be implemented with any one of a nickel-cadmium battery, a lead acid battery, a nickel metal hydride (NiMH) battery, a lithium ion battery and a lithium polymer battery.

The battery management system 22 can perform various functions of overcharge prevention, overdischarge prevention, overcurrent prevention, overvoltage prevention, overheat prevention, cell balancing, and the like of the battery cell 21. To this end, the battery management system 22 can measure a discharge current, temperature and the like of the battery cell 21, and output information on the discharge current and temperature of the battery cell 21 to the integrated controller 15. The integrated controller 15 can calculate the SOC of the battery cell 21, based on the information on the discharge current of the battery cell 21. In addition, the integrated controller 15 can control the amount of power charged in the battery cell 21, based on the information on the temperature of the battery cell 21.

FIG. 3 is a flowchart illustrating in detail a method for controlling the amount of power charged in the battery cell. Hereinafter, the method for controlling the amount of power charged in the battery cell of the energy storage system 1 will be described in conjunction with FIGS. 2 and 3.

In some embodiments, the procedure of FIG. 3 is implemented in a conventional programming language, such as C or C++ or another suitable programming language. The program can be stored on a computer accessible storage medium of the energy storage system 1, for example, a memory (not shown) of the power conversion system 10. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 3. The description of this paragraph applies to the embodiment shown in FIG. 5.

In step S101, the integrated controller 15 compares information on a temperature of the battery cell 21 to a predetermined threshold value (TH). The predetermined threshold value (TH) can be a sufficiently high temperature value of the battery cell 21.

In step S102, when the temperature of the battery cell 21 is greater than the predetermined threshold value (TH), the integrated controller 15 lowers the amount of power charged in the battery cell 21 so as to lower the temperature of the battery cell 21. In the zero house mode, the control of the amount of power charged in the battery cell 21 depends on the control of the amount of power generated from the power generation system 2. Because the power is not supplied from the grid 3 in the zero house mode, the amount of power generated from the power generation system 2 can be calculated by the sum of the amount of power consumed in the load 4 and the amount of power charged in the battery cell 21. Thus, when the amount of power consumed in the load 4 is constant, the energy storage system 1 reduces the amount of power generated from the power generation system 2, so that it is possible to reduce the amount of power charged in the battery cell 21.

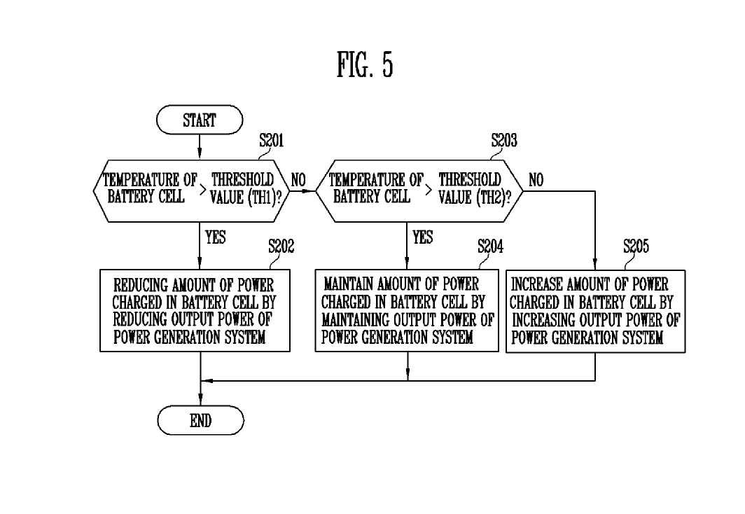

Hereinafter, a method for controlling the amount of power generated in the power generation system 2 will be described in detail in conjunction with FIG. 4. In FIG. 4, a solar power generation system has been illustrated as an example of the power generation system 2.

FIG. 4 is a graph illustrating output power with respect to an output voltage of the solar power generation system. In FIG. 4, the maximum value of output power Po will be defined as a max power point (MPP), and the output voltage Vo in the MPP will be defined as a maximum power voltage Vmp.

Referring to FIG. 4, the output power Po of the solar power generation system is substantially proportional to the output voltage Vo in a range where the output voltage Vo is below the maximum power voltage Vmp. The output power Po of the solar power generation system is substantially inversely proportional to the output voltage Vo in where the output voltage Vo is greater than the maximum power voltage Vmp. In addition, the graph of the output power Po with respect to the output voltage Vo can be changed depending on the amount of sunlight. As the amount of sunlight increases, the output power Po corresponding to any one output voltage Vo can be increased.

The power converting unit 11 can calculate an MPP and a maximum power voltage Vmp by performing the MPPT under the control of the integrated controller 15. The power converting unit 11 can decide whether a current output voltage Voc of the power generation system 2 is greater than the maximum power voltage Vmp. When the current output voltage Voc is less than or equal to the maximum power voltage Vmp, the power converting unit 11 controls a voltage Vof to be output from the power generation system 2 to become lower than the current output voltage Voc as shown in Equation 1. Accordingly, the output power of the power generation system 2 can be lowered.

Vof=Voc−Vstep Equation 1

In Equation 1, Vof denotes a voltage to be output from the power generation system 2, Voc denotes the current output voltage of the power generation system 2, and Vstep denotes a predetermined voltage step.

When the current output voltage Voc is greater than the maximum power voltage Vmp, the power converting unit 11 controls a voltage Vof to be output from the power generation system 2 to become greater than the current output voltage Voc as shown in Equation 2. Accordingly, the output power of the power generation system 2 can become high.

Vof=Voc+Vstep Equation 2

As described above, when the temperature of the battery cell 21 is greater than the predetermined threshold value (TH), the integrated controller 15 according to this embodiment controls the power converting unit 11 so as to control the output voltage, thereby lowering the output power. As a result, in this embodiment, the amount of power charged in the battery cell 21 is reduced when the temperature of the battery cell 21 is greater than the predetermined threshold value (TH), thereby lowering the temperature of the battery cell 21.

In step S103, the integrated controller 15 can increase the amount of power charged in the battery cell 21 when the temperature of the battery cell 21 is less than or equal to the predetermined threshold value (TH). To this end, the integrated controller 15 controls the power converting unit 11 to increase the amount of power generated from the power generation system 2. The energy storage system 1 can increase the amount of power generated from the power generation system 2, thereby increasing the amount of power charged in the battery cell 21.

Specifically, the power converting unit 11 can calculate the MMP and the maximum power voltage Vmp by performing the MMPT under the control of the integrated controller 15. The power converting system 11 decides whether the current output voltage Voc is greater than the maximum power voltage Vmp. When the current output voltage Voc is less than or equal to the maximum power voltage Vmp, the power converting unit 11 controls the voltage Vof to be output to become greater than the current output voltage Voc as shown in Equation 2. Accordingly, the output power of the power generation system 2 can become high.

When the current output voltage Voc of the power generation system 2 is greater than the maximum power voltage Vmp, the power converting unit 11 controls the voltage Vof to become lower than the current output voltage Voc as shown in Equation 1. Accordingly, the output power of the power generation system 2 can become low.

As described above, when the temperature of the battery cell 21 is less than or equal to the predetermined threshold value (TH), the integrated controller 15 according to this embodiment controls the power converting unit 11 to control the output voltage of the power generation system 2, thereby increasing the output power of the power generation system 2. As a result, in this embodiment, the amount of power charged in the battery cell 21 is increased when the temperature of the battery cell 21 is less than or equal to the predetermine threshold value (TH), thereby increasing the charging speed of the battery cell 21.

FIG. 5 is another flowchart illustrating in detail the method for controlling the amount of power charged in the battery cell. Hereinafter, the method for controlling the amount of power charged in the battery cell of the energy storage system according to this embodiment will be described in conjunction with FIGS. 2 and 5.

In step S201, the integrated controller 15 compares information on a temperature of the battery cell 21 with a first threshold value (TH1). The first threshold value (TH1) can be a predetermined sufficiently high temperature value of the battery cell 21.

In step S202, when the temperature of the battery cell 21 is greater than the first threshold value (TH1), the integrated controller 15 controls the amount of power charged in the battery cell 21 to be reduced in order to lower the temperature of the battery cell 21. In the zero house mode, the control depends on the control of the amount of power generated from the power generation system 2. Because the power is not supplied from the grid 3 in the zero house mode, the amount of power generated from the power generation system 2 can be calculated by the sum of the amount of power consumed in the load 4 and the amount of power charged in the battery cell 21. Thus, when the amount of power consumed in the load 4 is constant, the energy storage system 1 reduces the amount of power generated from the power generation system 2, so that it is possible to reduce the amount of power charged in the battery cell 21. To this end, the integrated controller 15 controls the power converting unit 11 to reduce the amount of power generated from the power generation system 2.

In step S203, when the temperature of the battery cell 21 is not greater than the first threshold value TH1, the integrated controller 15 compares the temperature to a second threshold value (TH2). The second threshold value (TH2) is a predetermined sufficiently low value of the battery cell 21.

In step S204, when the temperature of the battery cell 21 is less than or equal to the first threshold value (TH1) and greater than the second threshold value (TH2), the integrated controller 15 maintains the amount of power charged in the battery cell 21. In this case, the integrated controller 15 maintains the amount of power generated from the power generation system 2.

In step S205, when the temperature of the battery cell 21 is less than or equal to the second threshold value (TH2), the integrated controller 15 can control the amount of power charged in the battery cell 21 to be increased. To this end, the integrated controller 15 controls the power converting unit 11 to increase the amount of power generated from the power generation system 2. The energy storage system 1 can increase the amount of power generated from the power generation system 2, thereby increasing the amount of power charged in the battery cell 21.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment can be used singly or in combination with features, characteristics, and/or elements described in connection with other embodiments unless otherwise specifically indicated. Accordingly, it will be understood by those of skill in the art that various changes in form and details can be made without departing from the spirit and scope of the inventive technology as set forth in the following claims.

What is claimed is:

1. An energy storage system, comprising:
a battery system including:
at least one battery cell having a first power; and
a battery management system configured to measure and output the temperature of the battery cell;
a power generation system configured to generate and output a second power; and
a power management system configured to i) receive the second power, ii) charge the battery cell with the second power, iii) supply the first and second powers to a load, and iv) control the amount of the second power to be charged based at least in part on the temperature.

2. The energy storage system of claim 1, wherein the power management system includes:
a power converter configured to control the amount of the second power to be charged; and
an integrated controller configured to control the power converter based at least in part on the temperature.

3. The energy storage system of claim 2, wherein the power converter is further configured to reduce the amount of the second power to be charged when the temperature of the battery cell is greater than a first threshold value.

4. The energy storage system of claim 3, wherein the power converter is configured to increase the amount of the second power to be charged when the temperature of the battery cell is less than or equal to the first threshold value.

5. The energy storage system of claim 3, wherein the power converter is further configured to maintain the amount of the second power to be charged when the temperature of the battery cell is less than or equal to the first threshold value and greater than a second threshold value.

6. The energy storage system of claim 5, wherein the power converter is configured to increase the amount of the second power to be charged when the temperature of the battery cell is less than or equal to the second threshold value.

7. The energy storage system of claim 2, wherein the power management system further includes:
an inverter electrically connected between the power converter and a grid or the load and configured to i) convert a direct current (DC) voltage received from the power converter into an AC voltage and ii) supply the converted AC voltage to the grid or the load; and
a DC-DC converter electrically connected between the power converter and the battery system and configured to i) convert the voltage output of the power converter into a first DC voltage when the battery cell is being charged, ii) transfer the first DC voltage which is the same as the second power, iii) convert the second power received from the battery cell into a second DC voltage when the battery cell is being discharged, and iv) transfer the second DC voltage to the inverter.

8. A method for driving an energy storage system, the method comprising:
measuring the temperature of a battery cell; and
controlling the amount of power to be charged in the battery cell based at least in part on the measured temperature when the battery cell is being charged.

9. The method of claim 8, further comprising outputting power at a power generation system, wherein the controlling includes reducing the amount of the power output from the power generation system so as to reduce the power charged in the battery cell when the temperature of the battery cell is greater than a first threshold value.

10. The method of claim 9, wherein the controlling further includes increasing the amount of the power output from the power generation system so as to increase the power charged in the battery cell when the temperature of the battery cell is less than or equal to the first threshold value.

11. The method of claim 9, wherein the controlling further includes maintaining the amount of the power output from the power generation system so as to maintain the power charged in the battery cell when the temperature of the battery cell is less than or equal to the first threshold value and greater than a second threshold value.

12. The method of claim 11, wherein the controlling further includes increasing the amount of the power output from the power generation system so as to increase the amount of the power charged in the battery cell when the temperature of the battery cell is less than or equal to the second threshold value.

13. An energy storage system, comprising:
a battery system including:
at least one battery cell; and
a battery management system configured to measure and output the temperature of the battery cell; and
a power management system configured to i) receive power from a power generation system, ii) transfer the received power to the battery cell, and iii) control the amount of power to be charged in and discharged from the battery cell based at least in part on the temperature.

14. The energy storage system of claim 13, wherein the power management system includes:
a power converter configured to control the amount of the received power to be transferred; and
an integrated controller configured to control the power converter based at least in part on the temperature of the battery cell.

15. The energy storage system of claim 14, wherein the power converter is further configured to reduce the amount of the received power to be transferred when the temperature of the battery cell is greater than a first threshold value.

16. The energy storage system of claim 14, wherein the power converter is further configured to maintain the amount of received power to be transferred when the temperature of the battery cell is less than or equal to the first threshold value and greater than a second threshold value.

17. The energy storage system of claim 16, wherein the power converter is further configured to increase the amount of received power to be transferred when the temperature of the battery cell is less than or equal to the second threshold value.

18. The energy storage system of claim 14, wherein the power management system further includes:
an inverter electrically connected between the power converter and a grid or a load and configured to i) convert a direct current (DC) voltage received from the power converter into an AC voltage and ii) supply the converted AC voltage to the grid or the load; and
a bidirectional DC-DC converter electrically connected between the power converter and the battery system and configured to i) convert the voltage output from the power converter into a first DC voltage when the battery cell is being charged, ii) convert the voltage output from the battery cell into a second DC voltage when the battery cell is being discharged, and iii) transfer the second DC voltage to the inverter.
